(19) United States
(12) Patent Application Publication
(10) Pub. No.: US 2008/0174404 A1
(43) Pub. Date: Jul. 24, 2008

(54) DYNAMIC UPDATES IN RFID MANAGER

(75) Inventors: Krishnan Gopalan, Hyderabad (IN); Arunkumar C., Kerala (IN)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/625,862

(22) Filed: Jan. 23, 2007

(51) Int. Cl. H04Q 5/22

(52) U.S. Cl. 340/10.1

(57) ABSTRACT

The claimed subject matter provides a system and/or a method that facilitates managing and/or monitoring data within a radio frequency identification (RFID) network. The RFID network can include at least one device that receives data from a tag, wherein the RFID network can employ an RFID process that can utilize at least a portion of the data received from the tag. An update component can dynamically collect a status related to a portion of at least one of the device, the tag, the RFID process, a component, and/or the RFID network to enable real-time and continuous monitoring thereof.

### BACKGROUND

Many retail, manufacture, and distribution establishments are applying different and innovative operating methods to increase efficiency. These establishments can monitor store inventory to facilitate optimizing supply and demand relating to consumers. One aspect of maximizing profit hinges on properly stocking inventory such that replenishment occurs in conjunction with exhaustion of goods and/or products. For example, a retailer selling a computer and/or a VCR, must stock the computer in relation to its consumer sales, and the VCR in relation to its consumer sales. Thus, if the computer is in higher demand (e.g. more units sold) than the VCR, the retailer can stock the computer more frequently in order to optimize supply and demand, and in turn, profit. Monitoring inventory and associated sales can be a complex task, wherein product activity is comparable to a black box since inner workings are unknown; yet monitoring products is a crucial element in inventory/product efficiency.

Automatic identification and data capture (AIDC) technology, and specifically, Radio Frequency Identification (RFID) has been developed based at least upon the need to cure deficiencies of typical monitoring systems and/or methodologies (e.g., barcode readers, barcodes, and/or UPCs). RFID is a technique of remotely storing and retrieving data utilizing RFID tags. Since RFID systems are based upon radio frequency and associated signals, numerous benefits and/or advantages precede traditional techniques in monitoring products. RFID technology does not require a line of sight in order to monitor products and/or receive signals from RFID tags. Thus, no manual scan is necessary wherein the scanner is required to be in close proximity of the target (e.g., product). Yet, range is limited in RFID based upon radio frequency, RFID tag size, and associated power source. Additionally, RFID systems allow multiple reads within seconds providing quick scans and identification. In other words, an RFID system allows a plurality of tags to be read and/or identified when the tags are within a range of an RFID reader. The capability of multiple reads in an RFID system is complimented with the ability of providing informational tags that contain a unique identification code to each individual product.

Moreover, RFID systems and/or methodologies provide real-time data associated to a tagged item. Real-time data streams allow a retailer, distributor, and/or manufacturer the ability to monitor inventory and/or products with precision. Utilizing RFID can further facilitate supplying products on a front-end distribution (e.g., retailer to consumer) and a back-end distribution (e.g. distributor/manufacturer to retailer). Distributors and/or manufacturers can monitor shipments of goods, quality, amount, shipping time, etc. In addition, retailers can track the amount of inventory received, location of such inventory, quality, shelf life, etc. The described benefits demonstrate the flexibility of RFID technology to function across multiple domains such as, front-end supply, back-end supply, distribution chains, manufacturing, retail, automation, etc.

An RFID system consists of at least an RFID tag and an RFID transceiver. The RFID tag can contain an antenna that provides reception and/or transmission to radio frequency queries from the RFID transceiver. The RFID tag can be a small object, such as, for example, an adhesive sticker, a flexible label and integrated chip, etc. There are typically four different frequencies the RFID tags utilize: low frequency tags (between about 125 to 134 kilohertz), high frequency tags (about 13.56 megahertz), UHF tags (about 868 to 956 megahertz) and Microwave tags (about 2.45 gigahertz).

In general, an RFID system can include multiple components: tags, tag readers (e.g. tag transceivers), tag writers, tag-programming stations, circulation readers, sorting equipment, tag inventory wands, etc. Such RFID systems can collect and/or accumulate an immense amount of data, wherein utilizing such massive amounts of data need to be accurately observed and/or implemented. In particular, most administrative consoles require manual refreshing in relation to devices, components, etc. such that manual refreshment can misrepresent data within RFID systems. In light of the multiple components associated with an RFID system, manual refreshing respective to each component can be time-consuming, inefficient, redundant, and/or costly.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate collecting data related to at least one of an RFID network and/or an RFID process to enable a real-time, dynamic update. An update component can collect and/or gather real-time data related to most any suitable entity and/or portion of an entity, wherein the entity can associate with at least one of an RFID server, the RFID network, and/or the RFID process. In particular, the dynamic and continuous updates can correspond to a device, a tag, a portion of code related to the RFID process, a portion of code, a component associated with the RFID process (e.g., an event handler, an aggregation, a transformation, a filter, a portion of managed code running in context of the RFID process, etc.), a machine related to the RFID process, a machine related to the RFID network, a machine related to the RFID server, a machine related to a host providing a portion of an RFID service, etc. Conventionally techniques provide updates by polling for data on a cycle and/or periodic manner such that gaps of time and respective information were not captured.

The update component can enable real-time data management associated with a device that can receive data from a tag within the RFID network. The device can be, but is not limited to being, an RFID reader, an RFID writer, an RFID printer, a printer, a reader, a writer, an RFID transmitter, an antenna, a sensor, a real-time device, an RFID receiver, a real-time sensor, a device extensible to a web service, and a real-time event generation system. Moreover, the update component can provide dynamic updates related to an RFID process. The RFID process can relate to a particular RFID sub-system (e.g. an RFID server, RFID network, etc.) that is an uber or high-level object that forms together various entities to create a meaningful unit of execution. In yet another aspect in accordance with the claimed subject matter, the update component can automatically and continuously provide real-time data associated with at least one of the RFID service, the RFID network, the RFID network, the RFID host, the RFID server, and/or most any combination thereof. In other aspects of the claimed subject matter, methods are provided that facilitate employing continuous and real-time updates associated with monitoring and/or managing at least one of an RFID network and/or an RFID process.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates collecting data related to at least one of an RFID network and/or an RFID process to enable a real-time, dynamic update.

FIG. 2 illustrates a block diagram of an exemplary system that facilitates employing continuous and real-time updates associated with monitoring and/or managing at least one of an RFID network and/or an RFID process.

FIG. 3 illustrates a block diagram of an exemplary system that facilitates gleaning real-time data from at least one of an RFID network and/or an RFID process to improve monitoring and/or management accuracy.

FIG. 4 illustrates a block diagram of an exemplary system that facilitates utilizing real-time dynamically collected data corresponding to at least one of an RFID network and/or an RFID process.

FIG. 5 illustrates a block diagram of an exemplary system that facilitates collecting data from an RFID device within an RFID network.

FIG. 6 illustrates a block diagram of an exemplary system that facilitates dynamically providing real-time updates associated with an RFID server.

FIG. 7 illustrates a block diagram of exemplary systems that facilitate employing real-time data associated with an RFID server.

FIG. 8 illustrates an exemplary user interface for displaying dynamically collected real-time data associated with at least one of an RFID server and/or host.

FIG. 9 illustrates an exemplary methodology that facilitates collecting data related to at least one of an RFID network and/or an RFID process to enable a real-time, dynamic update.

FIG. 10 illustrates an exemplary methodology for employing continuous and real-time updates associated with monitoring and/or managing at least one of an RFID network and/or an RFID process.

FIG. 11 illustrates an exemplary networking environment, wherein the novel aspects of the claimed subject matter can be employed.

FIG. 12 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “interface,” “manager,” “device,” “tag,” “process,” and the like are intended to refer to a computer-related entity, either hardware, software (e.g. in execution), and/or firmware. For example, a component can be a process running on a processor, a processor, an object, an executable, a program, and/or a computer. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

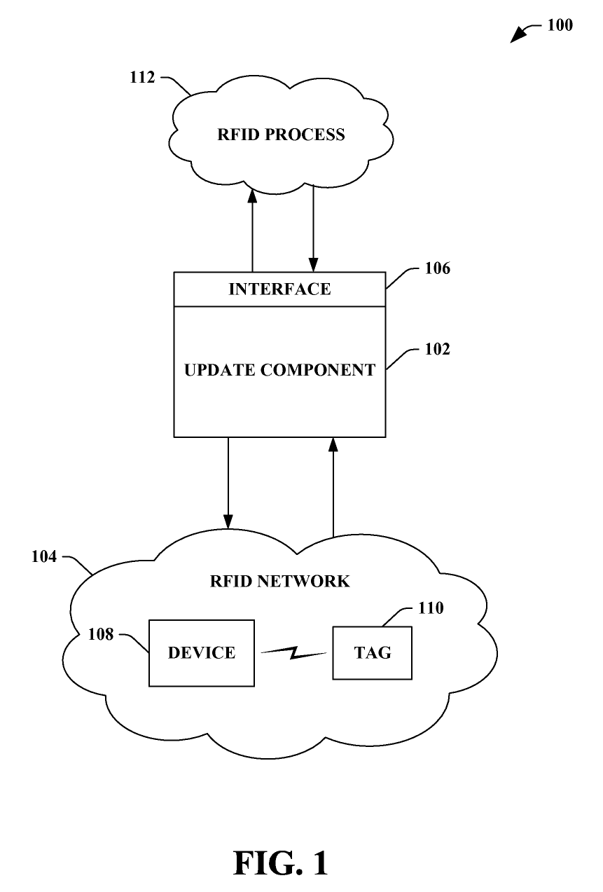

Now turning to the figures, FIG. 1 illustrates a system 100 that facilitates collecting data related to at least one of a radio frequency identification (RFID) network and/or an RFID process to enable a real-time, dynamic update. The system 100 can include an update component 102 that provides real-time dynamic updates in relation to at least one of an RFID network 104 and/or an RFID process 112. The update component 102 can collect data associated with the RFID process 112 via an interface component 106 (discussed in more detail infra), wherein the update component 102 can continuously provide real-time data associated therewith. In general, the update component 102 can utilize the interface component 106 to gather most any suitable data related to at least one of the RFID process 112 and/or the RFID network 104. In other words, the update component 102 allows the dynamic collection of data associated with most any suitable entity corresponding to a host and/or an RFID server related to one or more of the RFID network 104 and the RFID process 112. It is to be appreciated that update component 102 can dynamically gather and/or display real-time data in connection with a process, an RFID process, and/or an RFID business process. For example, the state of a process, an RFID process, and/or RFID business process can be dynamically updated. Conventionally techniques provide updates by polling for data on a cycle and/or periodic manner such that gaps of time and respective information were not captured.

The update component 102 can gather real-time updates to enable dynamic monitoring and/or management of most any suitable entity related to an RFID server, the RFID network 104, and/or the RFID process 112. In particular, the dynamic and continuous updates can correspond to a device 108, a tag 110, a portion of code related to the RFID process 112, a portion of an RFID process, a portion of code, a component associated with the RFID process 112 (e.g., an event handler, an aggregation, a transformation, a filter, a portion of managed code running in context of the RFID process, etc.), a machine related to the RFID process 112, a machine related to the RFID network 104, a machine related to the RFID server, a machine related to a host providing a portion of an RFID service, etc. By employing real-time, continuous updates, the update component 102 can enable seamless data acquisition, wherein data is constantly up-to-date without any lag, gaps of data collection, and/or delay.

It is to be appreciated that the device 108 within the RFID network 104 can receive a signal from, for instance, at least one tag 110 and/or a plurality of tags. In one example, the tag 110 can contain an antenna that provides reception and/or transmission to radio frequency queries from the device 108. Furthermore, it is to be appreciated that the device 108 within the RFID network 104 can be, but is not limited to being, an RFID reader, an RFID writer, an RFID printer, a printer, a reader, a writer, an RFID transmitter, an antenna, a sensor, a real-time device, an RFID receiver, a real-time sensor, a device extensible to a web service, and a real-time event generation system. Additionally, although a single device 108 and tag 110 are depicted, it is to be appreciated that a plurality of devices 108 and tags 110 can be utilized with the system 100.

In one example, the RFID network 104 can include at least one device 108 that is associated with at least one RFID process 112. It is to be appreciated that the RFID process 112 can utilize any suitable number of devices 108 within the RFID network 104. The RFID process 112 can be related to a particular RFID sub-system (e.g., an RFID server, RFID network, etc.) that is an uber or high-level object that forms together various entities to create a meaningful unit of execution. The RFID process 112 can be and/or can include an outbound process (e.g., pick, pack, shipping scenario, etc.), a manufacturing process, a shipping process, a receiving process, tracking, data representation, data manipulation, data application, security, etc. For instance, the RFID process 112 can utilize the received tag data for processing within a pipeline allowing various components (e.g., event handlers, filters, transforms, aggregations, managed code running in the context of the RFID process 112, etc.) to implement such data as necessary. Additionally, the RFID process 112 can include and/or respond to a device service, a tag read, an event, a tag write, a device configuration, a geographic tracking, a number count, etc. It is to be appreciated that the process can have raw data collected via at least one device associated with the RFID network 104, wherein such raw data can be manipulated based at least in part upon a rule and/or a business rule engine (not shown).

Moreover, the system 100 can include any suitable and/or necessary interface component 106 (herein referred to as “interface 106”), which provides various adapters, connectors, channels, communication paths, etc. to integrate the update component 102 into virtually any operating and/or database system(s). In addition, the interface 106 can provide various adapters, connectors, channels, communication paths, etc., that provide for interaction with the update component 102, the RFID network 104, the RFID process 112 and any other device, entity, and/or component associated with the system 100.

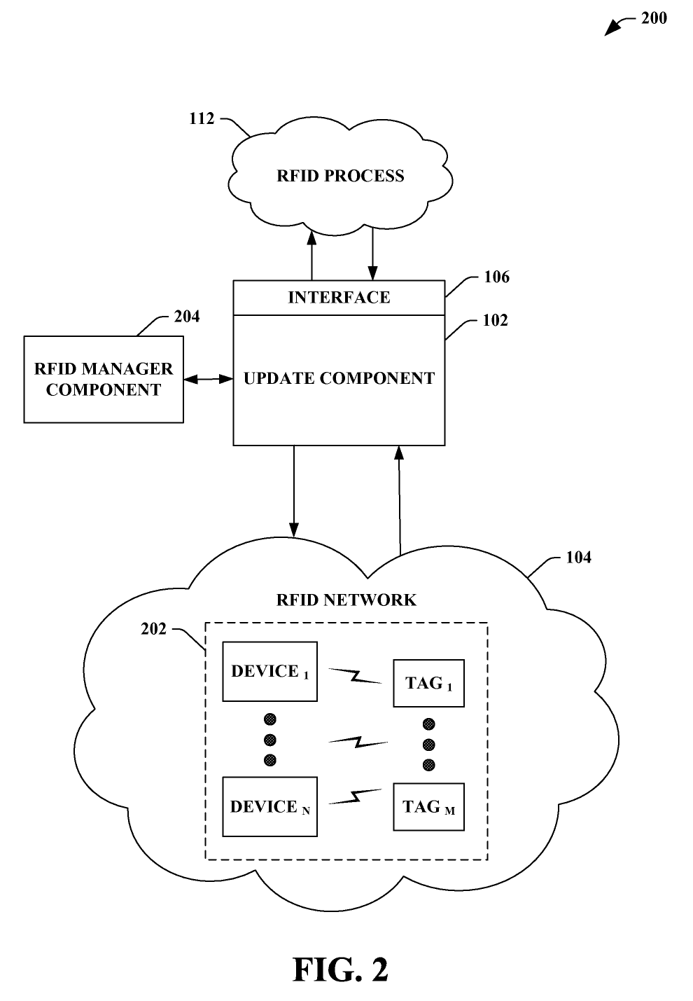

FIG. 2 illustrates a system 200 that facilitates employing continuous and real-time updates associated with monitoring and/or managing at least one of an RFID network and/or an RFID process. The system 200 can include the update component 102 that can enable continuous and dynamic updates related to most any suitable entity related to at least one of the RFID network 104, an RFID server (not shown), a host, and/or the RFID process 112. The updates can be provided in real-time, wherein such updates collected and/or gathered by the update component 102 can relate to, for instance, entity status, entity connectivity, entity details, entity responsiveness, entity state, etc. In other words, the update component 102 can provide real-time data updates related to most any entity within at least one of the RFID network 104, the RFID server, the host, the RFID process 112, and/or most any suitable combination thereof. In one example, the update component 102 can gather and/or collect real-time updates associated to the system 200 in order for an RFID manager component 204 to employ. It is to be appreciated that the RFID manager component 204 can manage and/or monitor the system 200 (e.g., the RFID network 104, the RFID server, the host, the RFID process 112, and/or most any entity associated to the system 200). For instance, the RFID manager 204 can provide administrative capabilities to the system 200 utilizing a graphical user interface (GUI), a user interface, and the like (discussed in more detail infra) to display data in real-time.

For instance, the update component 102 can provide dynamic real-time updates related to a shipping RFID process, related RFID devices, and/or associated RFID tags. In particular, the update component 102 can gather real-time information to allow dynamic monitoring of a state (e.g. process state, network state, host state, runtime state, most any state related to an entity within an RFID server/host), a setting (e.g., network setting, host setting, device setting, process setting, tag setting, data collection setting, tag read event setting, etc.), details/characteristics (e.g., network details, host details, device configurations, process details, tag characteristics/details, and the like), a status (e.g., process status, device status, network status, host status, tag status, etc.), a connectivity (e.g., network connection details, device connectivity, process connectivity, tag responsiveness, server/host connection, etc.), and the like associated with the shipping RFID process, related RFID devices, and/or associated RFID tags. Moreover, the update component 102 can further provide real-time updates associated with most any component related to the shipping RFID process (e.g., event handler, filter, aggregation, transformation, etc.).

The RFID network 104 can be implemented by any enterprise, business, facility, and/or any suitable entity that can utilize RFID technology. For instance, the RFID network 104 can be deployed to include any number of devices and tags 202 such as device 1 to device N, where N is positive integer. Moreover, such devices can interact (e.g., wirelessly communicate) with any number of tags such as tag 1 to tag M, where M is a positive integer to provide an event, a tag read event, a tag read, etc. It is to be appreciated that the devices can be at least one of the following: an RFID reader, an RFID writer, an RFID printer, an RFID transmitter, a sensor, a real-time device, an RFID receiver, a real-time sensor, a device extensible to a web service, a real-time event generator, etc. In addition, the device can be associated with at least an antenna to communicate data. Furthermore, it is to be appreciated that the tags can be associated to any suitable object related to the enterprise, business, facility, and/or any suitable entity utilizing such RFID technology.

The devices and tags 202 can be associated with at least one RFID process 112. It is to be appreciated that the RFID process 112 can run in the same host as a server (not shown and also referred to as an RFID server), the update component 102, and/or any combination thereof. Although only a single RFID process 112 is depicted, it is to be appreciated that a plurality of RFID processes can be executed in conjunction with the RFID network 104. The RFID network 104 can include various sub-systems and/or groups based at least in part upon device location, device functionality, device security level, process device association, make and/or model of device, type of device, device frequency, etc. For example, an RFID network 104 can include two groups and/or collections of devices, one at a shipping door and another at a receiving door. Such RFID network 204 can further include a process associated with each groups and/or collection of devices. For instance, the process can be a shipping process that is related to the devices at the shipping door, wherein the devices can collect data at such location. Similarly, another process can be a receiving process that is related to the devices at the receiving door, wherein the devices can collect data at such location.

Furthermore, the RFID process 210 can be a business process, wherein the devices can be indirectly utilized in association with the business process (not shown). In an example, an RFID stack can bridge the gap between devices and business applications. The business process can be, for instance, a business application to achieve a critical business function. For instance, the business application can be a back end application, an existing business application, a line of business (LOB) application, an accounting application, a supply chain management application, a resource planning application, and/or a business monitoring (BAM) application. In addition, the critical business function can be, for example, a demand plan, a forecast, and/or an inventory control with the incorporation of RFID data in real-time.

In another example, an RFID host and/or server associated with the RFID network 104 can utilize a business rules engine (not shown), wherein such business rules engine can provide a rule-based system in association with any application related to the RFID network 104 such that a filter and/or alert can be utilized as a rule(s). The business rules engine can execute declarative filters and/or alerts as rules associated with an RFID network 104, wherein the rules can include a rule set adhered to an event, condition, and action format utilizing an extensible markup language (XML). The rule is at least one of the following: contained within a rule set that adheres to an event, a condition, an action; and/or represented utilizing an extensible markup language (XML). Moreover, the condition has at least one of a set of predicates and/or a logical connective to form a logical expression that evaluates to one of a true and a false.

The RFID process 210 (also referred to as the process 210) can be an uber and/or high-level object that can provide a meaningful unit of execution. For instance, the process can be a shipping process that represents multiple devices at various dock doors working together to perform tag reads, filtering, read enrichment, alert evaluation, and data storage in a sink for a host application to retrieve/process. In another example, the process 210 can execute a manufacturing process, wherein devices are configured to read as well as write dependent upon a location. Moreover, additional functions such as filtering, alerting, enriching, etc. can be implemented at the location. In yet another example, the process can write to a tag process, wherein a tag can be written in real-time based at least upon an input. The write process can also check if the write succeeded by reading and passing data back to the host.

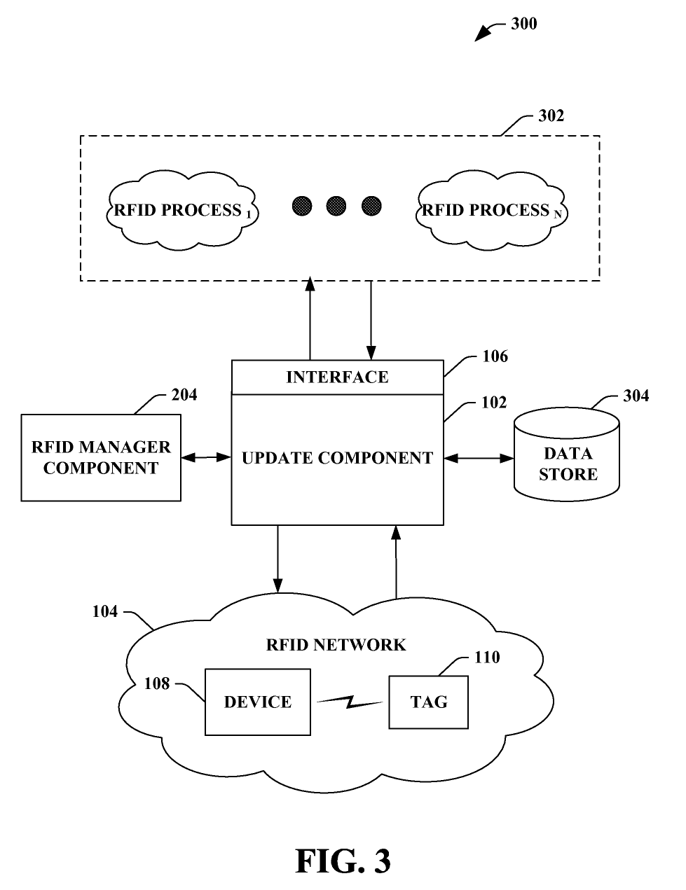

FIG. 3 illustrates a system 300 that facilitates gleaning real-time data from at least one of an RFID network and/or an RFID process to improve monitoring and/or management accuracy. The system 300 can include the update component 102 that can provide real-time updates and/or information related to an entity (e.g., a component, a device, a tag, a portion of code, a portion of data, etc.) associated with at least one of the RFID network 104, an RFID server/host, at least one RFID process 302, and/or any suitable combination thereof. It is to be appreciated that the update component 102 can collect data related to any suitable number of RFID networks, devices, tags, RFID servers, RFID hosts, and/or RFID processes 302. In particular there can be most any suitable number of RFID processes 302, such as RFID process₁ to RFID process_{N}, where N is a positive integer.

The system 300 can include a data store 304 that can store various data related to the system 300. For instance, the data store 304 can include most any suitable real-time data collected, gathered, and/or provided from an entity associated with at least one of the RFID network 104, the RFID server/host, the RFID process 302, and/or any combination thereof. For example, the data store 304 can store real-time data such as, but not limited to, RFID network status, RFID network state, RFID network details/information, RFID network connectivity, RFID network setting, RFID server/host status, RFID server/host state, RFID server/host details/information, RFID server/host connectivity, RFID server/host setting, device status, device state, device details/information, device connectivity, device setting, tag status, tag state, tag details/information, tag connectivity, tag setting, RFID process status, RFID process state, RFID process details/information, RFID process connectivity, RFID process setting, etc.

The data store 304 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 304 of the subject systems and methods is intended to comprise, without being limited to, these and any other suitable types of memory and/or storage. In addition, it is to be appreciated that the data store 304 can be a server, a database, a relational database, a hard drive, and the like.

The update component 102 can provide dynamic, real-time updates associated with the system 300. In particular, the update component 102 can provide real-time data to the RFID manager component 204 which can employ graphic user interface(s) for administering RFID services (e.g., RFID network, RFID process, devices, tags, etc.). The RFID manager component 204 can help monitor and/or manage RFID service(s) in real-time. For instance, the update component 102 can provide an exact state of a device (e.g., physical, simulated, virtual, etc.), RFID processes (e.g., shipping process, receiving process, business process, etc.), and/or most any other entities the administrator can diagnose to assist in resolving potential problems. In other words, the update component 102 can facilitate employing preventative maintenance for the RFID network based at least in part upon evaluating the real-time data collected associated therewith.

In one example, the update component 102 can provide the state of devices (e.g., RFID device, an RFID reader, an RFID writer, an RFID printer, a printer, a reader, a writer, an RFID transmitter, an antenna, a sensor, a real-time device, an RFID receiver, a real-time sensor, a device extensible to a web service, a real-time event generation system, etc.) and/or the state of RFID processes 302. For instance, the state of devices and RFID processes can change for a number of reasons. The state can change because of external factors (e.g. network connectivity, network down, user initiated actions, etc.) and/or internal factors. If the RFID device is “unreachable,” the device can go to a “failed” state. It is to be appreciated that the device state changed because of some internal and/or external factor. In another instance, the administrator can stop a started RFID process, which can take the process from a “Started” state to a “Stopped” state. It is to be appreciated that the RFID process state changed because of some user initiated action (e.g., stopping the process, etc.).

The update component 102 can provide dynamic, real-time updates that facilitate ascertaining the exact state of the RFID service at any point of time. By employing the update component 102, the following advantages can be provided: 1) the information displayed and/or provided can be ensured to be consistent with that in the RFID service and/or architecture; 2) the update component 102 can be utilized with the RFID manager 204 to eliminate conventional manual refreshing to ensure that the RFID system and/or service is working properly; and 3) the update component 102 can assist in resolving problems, errors, and/or other issues faster and more efficiently since the real-time state is displayed and/or known.

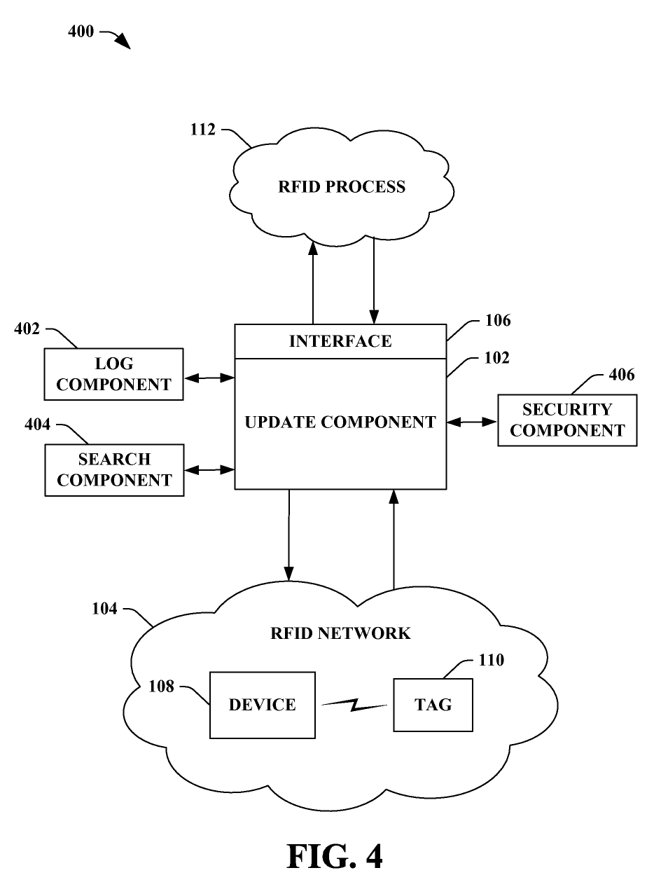

FIG. 4 illustrates a system 400 that facilitates utilizing real-time dynamically collected data corresponding to at least one of an RFID network and/or an RFID process. The update component 102 can utilize a log component 402 that tracks collected real-time data associated with the system 400. It is to be appreciated that the log component 402 can be a stand-alone component, incorporated into the update component 102, incorporated into an RFID server/host, incorporated into the RFID network 104, and/or any combination thereof. The log component 402 can log various real-time information related to an entity (e.g., a component, a device, a tag, a portion of code, a portion of data, etc.) associated with at least one of an RFID server/host, the RFID network 104, the RFID process 112, and/or any combination thereof. Moreover, the log component 402 can store the logged entries in a data store (not shown and discussed supra).

The update component 102 can further utilize a search component 404 that facilitates querying any data associated with the system 400. The search component 404 allows a user and/or any component to query to system 400 in relation to gathered real-time data corresponding to the RFID network, RFID server/host, RFID process, an entity related to an RFID system, etc. For instance, a user can query the system 400 utilizing the search component 404 to find a portion of real-time data related to a particular device within a specific RFID network. It is to be appreciated that a plurality of searches and/or queries can be implemented by the search component 404 and the above example is not to be limiting on the claimed subject matter. Moreover, it is to be appreciated that the search component 404 is depicted as a stand-alone component, but the search component 404 can be incorporated into the update component 102, incorporated into the RFID network 104, incorporated into the RFID server/host, a stand-alone component, and/or any combination thereof.

The update component 102 can further employ a security component 406 that provides security to the system 400 to ensure data integrity and/or access. In particular, the security component 406 can define security, authorization, and/or privileges in accordance with at least one of a pre-defined hierarchy, security level, username, password, access rights, data importance (e.g., more important data correlates with high security clearance), etc. For instance, a particular portion of real-time data can be a first security level with distinct security authorizations and/or privileges, while a disparate portion of real-time data can have a second security level with disparate security authorizations and/or privileges. Thus, the security component 406 can provide granular security in relation to most any collected and/or gathered real-time data It is to be appreciated that there can be various levels of security with numerous characteristics associated with each level and that the subject innovation is not limited to the above example. Moreover, the security component 406 provides granular security and/or privileges to the system 400. It is to be appreciated that security component 406 can be a stand-alone component, incorporated into the update component 102, incorporated into the RFID network 104, incorporated into the RFID server/host, and/or any combination thereof.

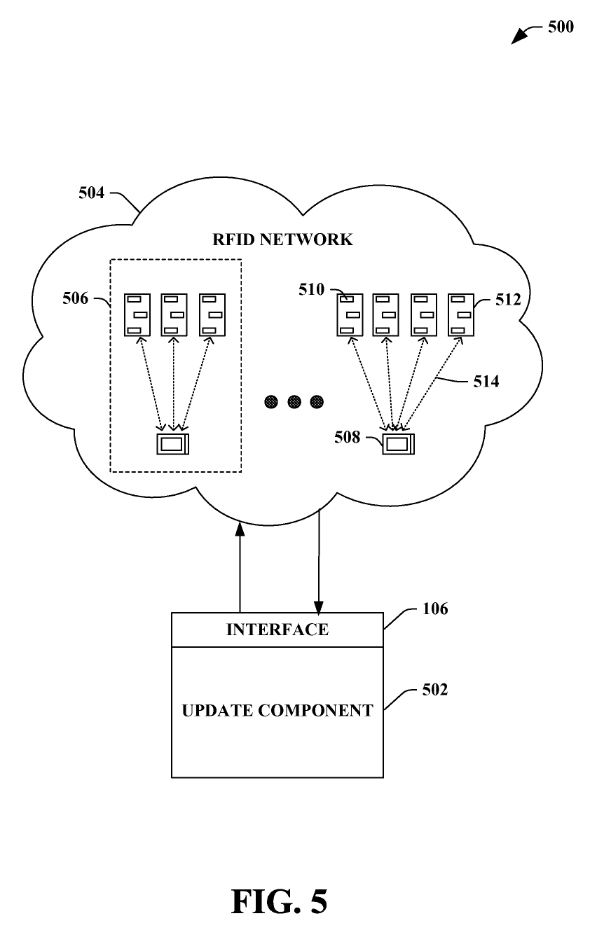

FIG. 5 illustrates a system 500 that facilitates collecting data from an RFID device within an RFID network. The system 500 can include an update component 502 that can collect real-time data related to an RFID network 504 and/or an RFID process (not shown). The update component 502 can provide real-time data related to an entity associated with at least one of an RFID server (not shown), an RFID host (not shown), the RFID network 504, the RFID process, and/or any combination thereof. Moreover, the real-time data and/or updates can be, but are not limited to, a status, a state, details/information, connectivity, a setting, etc. Furthermore, it is to be appreciated that the update component 502 and the RFID network 504 can be substantially similar to previously described figures.

The RFID network 504 can include a plurality of universes (e.g., sub-systems, RFID networks), wherein a universe is a server of RFID entities. For simplicity, the RFID network 504 illustrates a single universe containing two collections of devices (e.g., device collections), where a first collection 506 is shown. It is to be appreciated that the device collections can correspond to device groups as utilized by the batcher component 502, wherein such collections and/or groups can be based on at least one of the following: device physical location, device functionality, device security level, process device association, make and/or model of device, type of device, device frequency, etc. For instance, an RFID sub-system can be a location wherein the entities involved are related to a substantially similar process. In one example, a sub-system can be a warehouse containing a plurality of receiving and/or shipping dock doors with associated devices. Thus, first collection 506 can be a collection of devices within the specified sub-system. It is to be appreciated a plurality of collection of devices can be implemented. Within a collection of devices, a device 508 can receive an RFID signal 514 from a pallet of goods 512 containing at least one RFID tag 510. It is to be appreciated the pallets and/or goods can be tagged based at least upon user specifications (e.g., single pallets tagged, individual goods tagged, pallets and goods tagged, etc.).

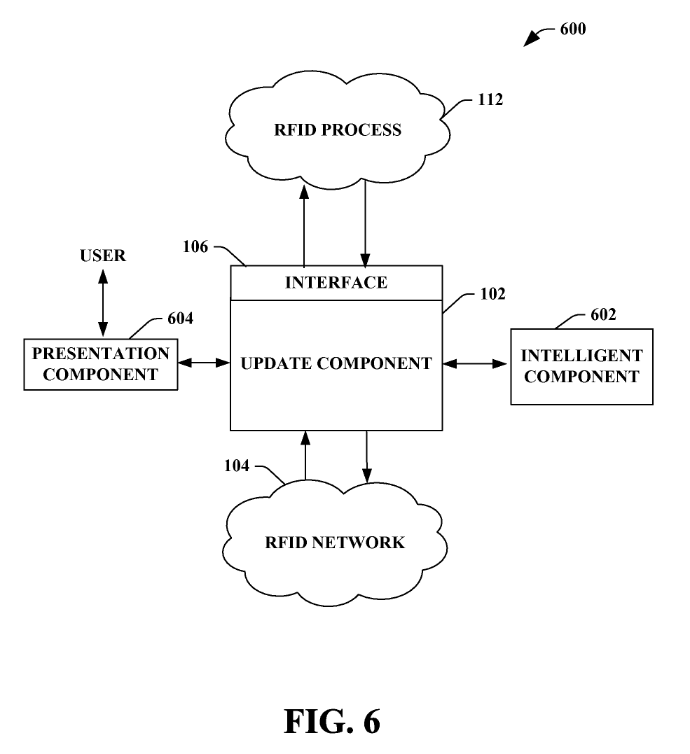

FIG. 6 illustrates a system 600 that employs intelligence to facilitate dynamically providing real-time updates associated with an RFID server. The system 600 can include the update component 102, the RFID network 104, the RFID process 112, and the interface 106 that can all be substantially similar to respective components, networks, processes, and interfaces described in previous figures. The system 600 further includes an intelligent component 602. The intelligent component 602 can be utilized by the update component 102 to facilitate continuously collecting real-time data. For example, the intelligent component 608 can infer state, status, connectivity, details/information, settings, reasons related to errors and/or issues, trouble-shooting, problem solving, entity data, RFID network data, RFID server data, RFID process data, device data, tag data, display settings, user profiles, graphic user interface (GUI) configurations, etc.

It is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g. support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The update component 102 can further utilize a presentation component 604 that provides various types of user interfaces to facilitate interaction between a user and any component coupled to the update component 102 and display of collected and/or gathered real-time data. As depicted, the presentation component 604 is a separate entity that can be utilized with the update component 102. However, it is to be appreciated that the presentation component 604 and/or similar view components can be incorporated into the update component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the update component 102.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

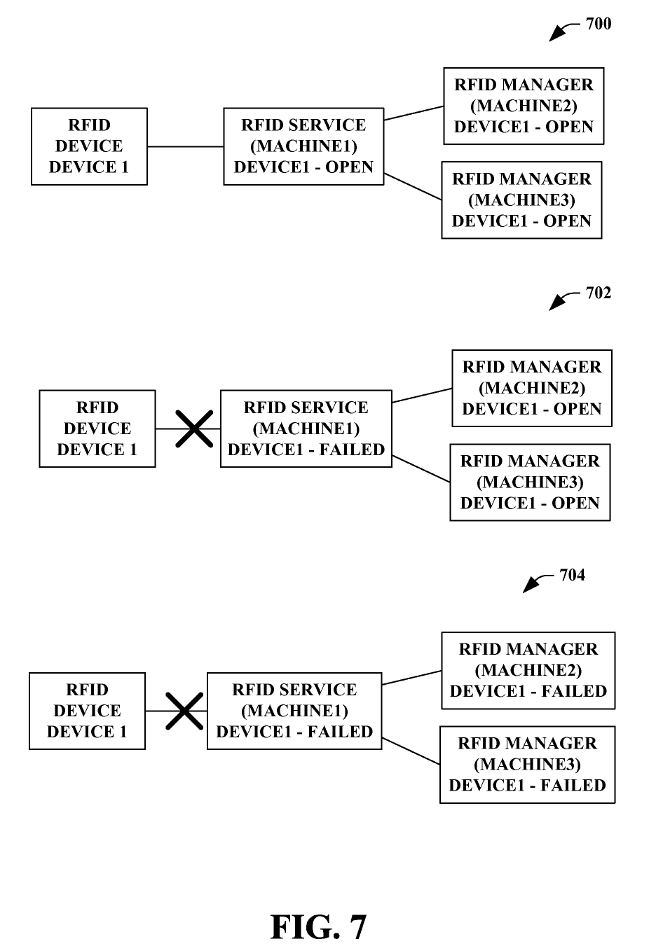

FIG. 7 illustrates a system 700 that facilitates employing real-time data associated with an RFID server. The system 700 illustrates an RFID service deployment in which an RFID device “device 1” is sending tags to the RFID service running in “machine 1.” It is to be appreciated that most any suitable number of administrators (e.g. one from the manufacturing department, one from the shipping department, etc.) can monitor the service from “machine 1” and “machine 2” respectively. For instance, “device 1” can be switched-off and the RFID service can take the device to a “failed” state. Conventional systems and/or techniques utilize manual refreshes in order to collect and/or gather data as illustrated in system 702.

System 702 illustrates the state of the RFID service as “failed” but is not refreshed in real-time so as to not illustrate the RFID manager on “machine 2” and “machine 3” as “failed.” In other words, based on the “failed” state of the RFID service on “machine 1,” the state of the RFID manager should be displayed as “failed” but due to the lapse and manual refresh necessary with conventional techniques, the RFID manager is not updated accurately.

Turning to the system 704, an update component (discussed supra) can be employed to provide dynamic and real-time updates/data associated with an RFID service, RFID network, RFID server, RFID host, RFID process, etc. With dynamic updates, the system 704 illustrates the state of the RFID manager on “machine 2” and “machine 3” as failed based on the “failed” status of the RFID service on “machine 1.” Thus, the system 704 provide accurate and dependable data based at least in part upon real-time data collection that can be displayed rather than conventional polling and/or manual refreshing techniques. With real-time updates, the device state can change and/or be updated in the RFID service as soon as the state changes to enable the RFID manager to be updated.

In particular, the dynamic updates in RFID manager can be based on Windows Management Instrumentation (WMI) events that are generated by the RFID service. The RFID manager can register to the RFID WMI namespace and receive the WMI events. Based on WMI events, the RFID manager automatically updates. In another example, the real-time updates can be provided by web based enterprise management (WBEM) which can send information about objects, computers, memory, entities, etc. to allow any platform software to describe its state. It is to be appreciated that any suitable operating system and/or platform management instrumentation software can be utilized. In particular, most any suitable technique that can dynamically provide real-time data can be employed with the subject innovation.

The following pseudo code can be employed in connection with providing dynamic, real-time updates. It is to be appreciated and understood that the following code is for exemplary purposes and not to be limiting on the claimed subject matter. In particular, the following code illustrates events in a WMIConsumer class which can act as a façade for the WMI events generated by RFID service:

```
internal class WMIConsumer
  {
      public delegate void
      ProcessStateChangedEventHandler(WMIConsumer
      consumer, ProcessStateChangedEventArgs e);
    public event ProcessStateChangedEventHandler
    ProcessStateChangedEvent;
    public delegate void ProcessAddedEventHandler(WMIConsumer
    consumer,
ProcessAddedEventArgs e);
    public event ProcessAddedEventHandler ProcessAddedEvent;
    public delegate void ProcessDeletedEventHandler(WMIConsumer
    consumer,
ProcessDeletedEventArgs e);
    public event ProcessDeletedEventHandler ProcessDeletedEvent;
    public delegate void
    DeviceStateChangedEventHandler(WMIConsumer
consumer, DeviceStateChangedEventArgs e);
    public event DeviceStateChangedEventHandler
    DeviceStateChangedEvent;
    public delegate void
    DeviceAddedEventHandler(WMIConsumer consumer,
DeviceRelatedEventArgs e);
    public event DeviceAddedEventHandler DeviceAddedEvent;
    public delegate void DeviceDeletedEventHandler(WMIConsumer
    consumer,
DeviceRelatedEventArgs e);
    public event DeviceDeletedEventHandler DeviceDeletedEvent;
    public delegate void DeviceRenamedEventHandler(WMIConsumer
    consumer,
DeviceRenamedEventArgs e);
    public event DeviceRenamedEventHandler DeviceRenamedEvent;
      }
```

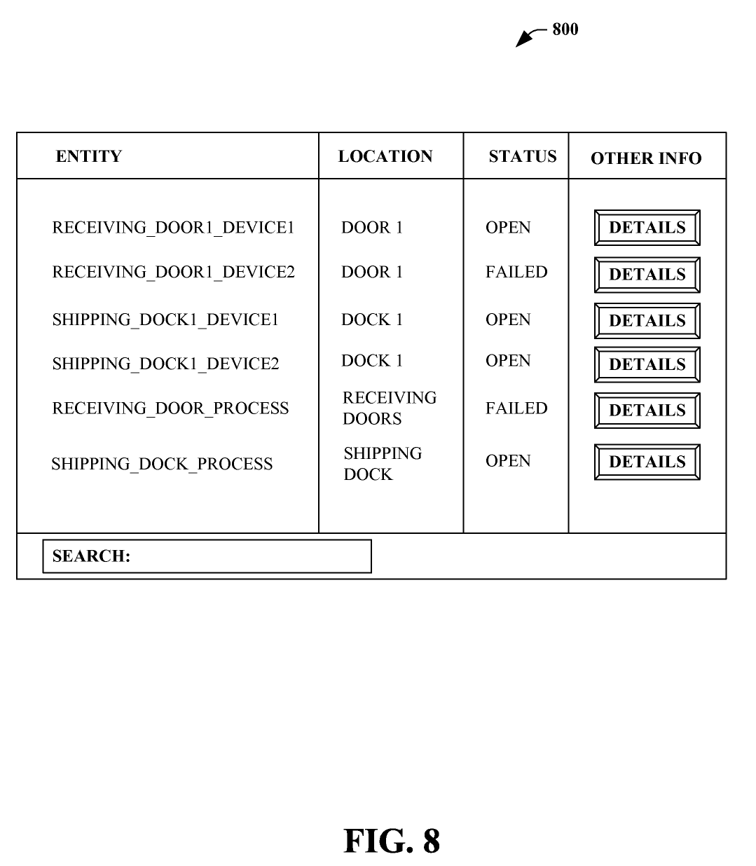

FIG. 8 illustrates an exemplary user interface 800 for displaying dynamically collected real-time data associated with at least one of an RFID server and/or host. The user interface 800 can be employed to dynamically monitor and/or display real-time data collected and/or gathered. It is to be appreciated that the user interface 800 is solely for example and not to be limiting on the subject innovation. For instance, various nuances and/or subtleties can be implemented but are to be considered within the scope of the claimed subject matter. The user interface 800 can include an entity reference (e.g., “receiving_door1_device1,” “shipping dock1_device2,” etc.), a respective location (e.g., “door1,” “dock1,” etc.), a status (e.g., “open,” “failed,” etc.), other information (e.g. accessed by activating “details”), etc. Moreover, the user interface 800 can provide a search portion that allows real-time data to be queried. It is to be appreciated that the user interface 800 can dynamically gather and/or display real-time data in connection with a process, an RFID process, and/or an RFID business process. For example, the state of a process, an RFID process, and/or RFID business process can be dynamically updated in, for instance, an RFID manager utilizing a Window Management Instrumentation event. In one example, there can be an RFID manager on Machine1 and an RFID manager on Machine2. There can be a process named Process1 in the RFID service that is in a stopped state. There further can be an RFID service on Machine3, wherein the Process1 on Machine1 can be started. The Process1 status can be updated immediately on Machine1 and Machien2 to a started state.

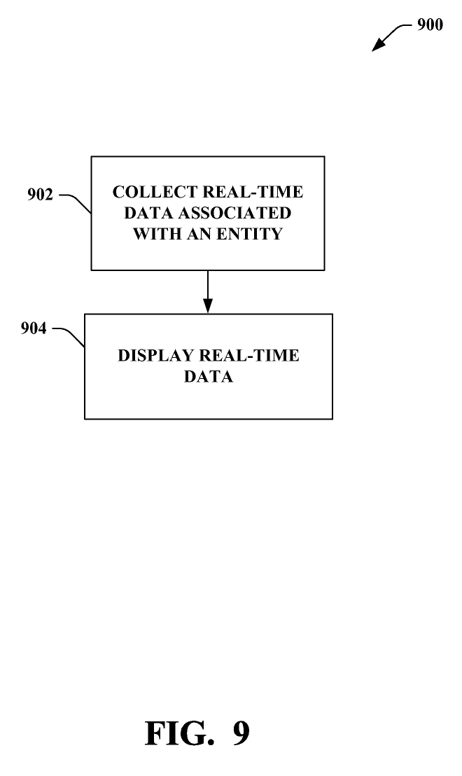

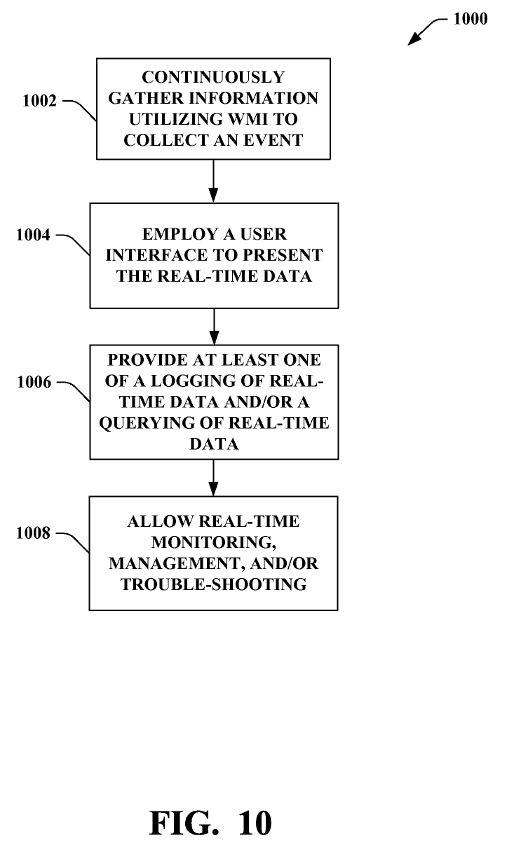

FIGS. 9-10 illustrate methodologies in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 9 illustrates a methodology 900 that facilitates collecting data related to at least one of an RFID network and/or an RFID process to enable a real-time, dynamic update. At reference numeral 902, real-time data associated with an entity can be collected. The entity (e.g., a component, a device, a tag, a portion of code, a portion of data, a portion of an RFID process, etc.) can be associated with at least one of the RFID network, an RFID server/host, at least one RFID process, and/or any suitable combination thereof. At reference numeral 904, the real-time data can be displayed. The real-time data can be displayed utilizing, for instance, a graphical user interface (GUI), a user interface (UI), a presentation component (discussed supra), etc. It is to be appreciated that the displayed real-time data can be in connection with a process, an RFID process, and/or an RFID business process. For example, the state of a process, an RFID process, and/or RFID business process can be dynamically updated.

It is to be appreciated that the real-time data can correspond to most any suitable entity, wherein the entity can be a device, a tag, a portion of code, a component, an event handler, a filter, an aggregation, a transform, a portion of an RFID process, a portion of an RFID network, a portion of an RFID server/host, and the like. For example, the device within the RFID network can be, but is not limited to being, an RFID reader, an RFID writer, an RFID printer, a printer, a reader, a writer, an RFID transmitter, an antenna, a sensor, a real-time device, an RFID receiver, a real-time sensor, a device extensible to a web service, and a real-time event generation system. Moreover, the device can relate to an RFID network. The RFID network can include at least one device that is associated with at least one RFID process. It is to be appreciated that the RFID process can utilize any suitable number of devices within the RFID network. An RFID process can be related to a particular RFID sub-system (e.g., an RFID server, RFID network, etc.) that is an uber or high-level object that forms together various entities to create a meaningful unit of execution. The RFID process can be an outbound process (e.g., pick, pack, shipping scenario, etc.), a manufacturing process, a shipping process, a receiving process, tracking, data representation, data manipulation, data application, security, etc.

FIG. 10 illustrates a methodology that facilitates employing continuous and real-time updates associated with monitoring and/or managing at least one of an RFID network and/or an RFID process. At reference numeral 1002, information can be continuously gathered utilizing Windows Management Instrumentation (WMI) to collect an event. The information can be collected in real-time, wherein the event can be generated and/or gathered by the RFID service. For instance, an RFID manager can listen and/or gather data from the RFID WMI namespace (discussed above) to receive at least one WMI event. Based at least in part upon such WMI events, dynamic updates can be provided and/or utilized.

At reference numeral 1004, a user interface (UI) can be employed to present the real-time data and/or information. For example, the UI can be utilized to display the gathered information to a user, a machine, an employee, an administrator, etc. At reference numeral 1006, at least one of a logging of real-time data and/or a querying of real-time data can be provided. In one instance, the gathered real-time data can be logged and/or tracked to enable such data to be queried. Thus, a search can be initiated to allow query results with current real-time data and/or historic real-time data. At reference numeral 1008, at least one of the following can be provided: real-time monitoring; real-time management; and/or real-time trouble-shooting.

The information and/or real-time data can relate to most any suitable entity such as a portion of code associated with an RFID process, a component, an event handler, a filter, an aggregation, a transform, a device within an RFID network, a portion of the RFID network, a portion of the RFID server, a portion of a host, a tag within an RFID network, and/or any suitable combination thereof. It is to be appreciated that the devices can be at least one of the following: an RFID reader, an RFID writer, an RFID printer, a printer, a reader, a writer, an RFID transmitter, an antenna, a sensor, a real-time device, an RFID receiver, a real-time sensor, a device extensible to a web service, a real-time event generation, etc. The RFID network can be implemented by any enterprise, business, facility, and/or any suitable entity that can utilize RFID technology. For instance, the RFID network can be deployed to include any number of devices such as device₁ to device_{N}, where N is positive integer. Moreover, such devices can interact (e.g., wirelessly communicate) with any number of tags such as tag₁ to tag_{M}, where M is a positive integer.

It is to be appreciated that the RFID process can utilize any suitable number of devices within an RFID network. The RFID process can be related to a particular RFID sub-system (e.g., an RFID server, RFID network, etc.) that is an uber or high-level object that forms together various entities to create a meaningful unit of execution. The RFID process can be and/or can include an outbound process (e.g. pick, pack, shipping scenario, etc.), a manufacturing process, a shipping process, a receiving process, tracking, data representation, data manipulation, data application, security, etc. Additionally, the RFID process can include and/or respond to a device service, a tag read, an event, a tag write, a device configuration, a geographic tracking, a number count, etc. It is to be appreciated that the process can have raw data collected via at least one device associated with the RFID network, wherein such raw data can be manipulated based at least in part upon a rule and/or a business rule engine (not shown).

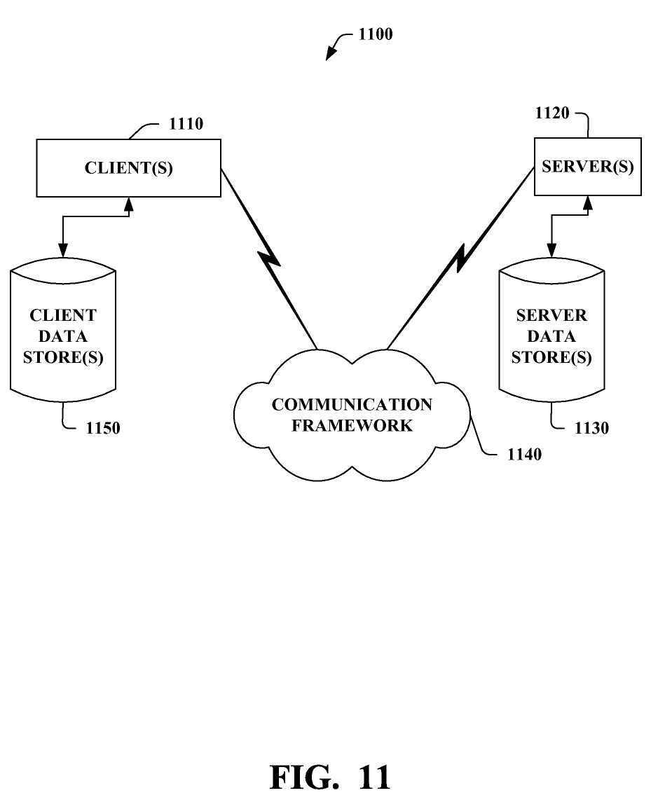

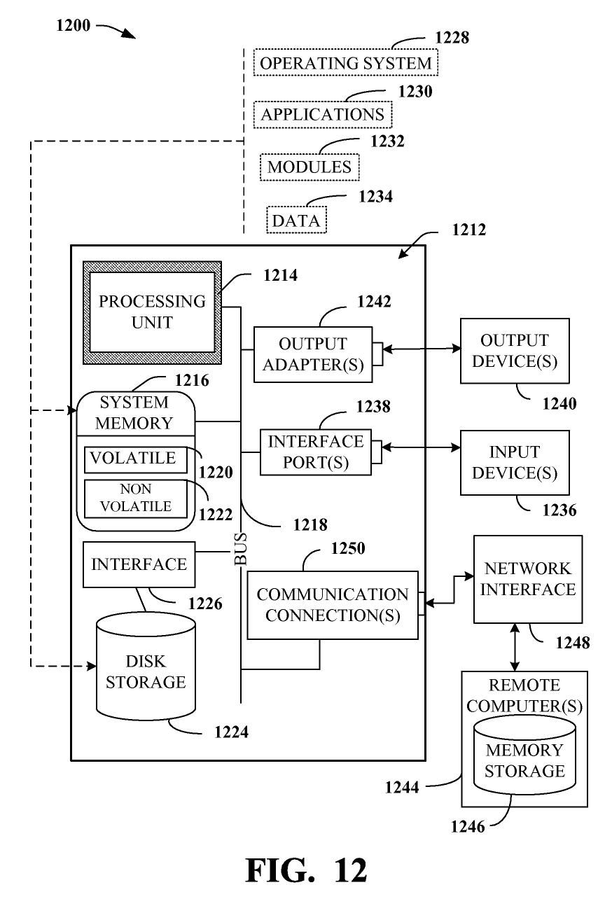

In order to provide additional context for implementing various aspects of the claimed subject matter, FIGS. 11-12 and the following discussion is intended to provide a brief, general description of a suitable computing environment in which the various aspects of the subject innovation may be implemented. For example, an update component that provides dynamic updates and/or real-time data related to at least one of a device, a tag, a portion of code related to the RFID process, a portion of code, a component associated with the RFID process (e.g., an event handler, an aggregation, a transformation, a filter, a portion of managed code running in context of the RFID process, etc.), a machine related to the RFID process, a machine related to the RFID network, a machine related to the RFID server, a machine related to a host providing a portion of an RFID service, etc., as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 11 is a schematic block diagram of a sample-computing environment 1100 with which the claimed subject matter can interact. The system 1100 includes one or more client(s) 1110. The client(s) 1110 can be hardware and/or software (e.g., threads, processes, computing devices). The system 1100 also includes one or more server(s) 1120. The server(s) 1120 can be hardware and/or software (e.g., threads, processes, computing devices). The servers 1120 can house threads to perform transformations by employing the subject innovation, for example.

One possible communication between a client 1110 and a server 1120 can be in the form of a data packet adapted to be transmitted between two or more computer processes. The system 1100 includes a communication framework 1140 that can be employed to facilitate communications between the client(s) 1110 and the server(s) 1120. The client(s) 1110 are operably connected to one or more client data store(s) 1150 that can be employed to store information local to the client(s) 1110. Similarly, the server(s) 1120 are operably connected to one or more server data store(s) 1130 that can be employed to store information local to the servers 1120.

With reference to FIG. 12, an exemplary environment 1200 for implementing various aspects of the claimed subject matter includes a computer 1212. The computer 1212 includes a processing unit 1214, a system memory 1216, and a system bus 1218. The system bus 1218 couples system components including, but not limited to, the system memory 1216 to the processing unit 1214. The processing unit 1214 can be any of various available processors. Dual microprocessors and other multiprocessor architectures also can be employed as the processing unit 1214.

The system bus 1218 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1216 includes volatile memory 1220 and nonvolatile memory 1222. The basic input/output system (BIOS), containing the basic routines to transfer information between elements within the computer 1212, such as during start-up, is stored in nonvolatile memory 1222. By way of illustration, and not limitation, nonvolatile memory 1222 can include read only memory (ROM), programmable ROM (PROM), electrically programmable ROM (EPROM), electrically erasable programmable ROM (EEPROM), or flash memory. Volatile memory 1220 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1212 also includes removable/non-removable, volatile/non-volatile computer storage media. FIG. 12 illustrates, for example a disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to the system bus 1218, a removable or non-removable interface is typically used such as interface 1226.

It is to be appreciated that FIG. 12 describes software that acts as an intermediary between users and the basic computer resources described in the suitable operating environment 1200. Such software includes an operating system 1228. Operating system 1228, which can be stored on disk storage 1224, acts to control and allocate resources of the computer system 1212. System applications 1230 take advantage of the management of resources by operating system 1228 through program modules 1232 and program data 1234 stored either in system memory 1216 or on disk storage 1224. It is to be appreciated that the claimed subject matter can be implemented with various operating systems or combinations of operating systems.

A user enters commands or information into the computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1214 through the system bus 1218 via interface port(s) 1238. Interface port(s) 1238 include, for example, a serial port, a parallel port, a game port, and a universal serial bus (USB). Output device(s) 1240 use some of the same type of ports as input device(s) 1236. Thus, for example, a USB port may be used to provide input to computer 1212, and to output information from computer 1212 to an output device 1240. Output adapter 1242 is provided to illustrate that there are some output devices 1240 like monitors, speakers, and printers, among other output devices 1240, which require special adapters. The output adapters 1242 include, by way of illustration and not limitation, video and sound cards that provide a means of connection between the output device 1240 and the system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. The remote computer(s) 1244 can be a personal computer, a server, a router, a network PC, a workstation, a microprocessor based appliance, a peer device or other common network node and the like, and typically includes many or all of the elements described relative to computer 1212. For purposes of brevity, only a memory storage device 1246 is illustrated with remote computer(s) 1244. Remote computer(s) 1244 is logically connected to computer 1212 through a network interface 1248 and then physically connected via communication connection 1250. Network interface 1248 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refers to the hardware/software employed to connect the network interface 1248 to the bus 1218. While communication connection 1250 is shown for illustrative clarity inside computer 1212, it can also be external to computer 1212. The hardware/software necessary for connection to the network interface 1248 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates monitoring data within an RFID network, comprising:
a radio frequency identification (RFID) network that includes at least one device that receives data from a tag;
the RFID network employs a radio frequency identification (RFID) process that utilizes at least a portion of the data received from the tag; and
an update component that dynamically collects a status related to a portion of at least one of the device, the tag, the RFID process, a component, or the RFID network to enable real-time and continuous monitoring thereof.

2. The system of claim 1, the RFID process is a high-level object that forms together at least one entity to create a meaningful unit of execution that relates to at least one of the following: an outbound process; a manufacturing process; a shipping process; a receiving process; a tracking process; a data representation process; a data manipulation process; a security process; and a process utilizing one of an RFID device service, a device collection, a tag read, an event, an event queue, a tag write, a device configuration, or a number count.

3. The system of claim 1, the device is one of the following: an RFID reader; an RFID writer; an RFID printer; a reader; a writer; an RFID transmitter; an antenna; a sensor; a real-time device; an RFID receiver; a real-time sensor; a device extensible to a web service; or a real-time event generation system.

4. The system of claim 1, the component is at least one of an event handler, a filter, a transform, an aggregation, a portion of managed code running in a context of the RFID process, or an event handler that employs a transformation on data received from the tag.

5. The system of claim 1, the update component collects at least one Window Management Instrumentation (WMI) event generated by the RFID network to enable the real-time and continuous monitoring.

6. The system of claim 1, the update component provides the real-time and continuous monitoring based at least in part upon a portion of an operating system management instrumentation event.

7. The system of claim 1, further comprising an RFID manager component that utilizes the dynamically collected status to facilitate managing the RFID network.

8. The system of claim 7, the RFID manager component receives at least one operating system management instrumentation event to enable automatic and dynamic status updates.

9. The system of claim 1, the update component is utilized by an administrator console to provide automatic and dynamic real-time status update.

10. The system of claim 1, further comprising at least one of a user interface (UI) and/or a graphical user interface (GUI) to automatically display at least a portion of real-time status update.

11. The system of claim 1, further comprising a log component that tracks dynamically collected real-time data from a portion of at least one of the device, the tag, the RFID process, a component, or the RFID network.

12. The system of claim 1, further comprising a search component that enables dynamically collected real-time data to be queried.

13. The system of claim 1, further comprising a security component that ensures data integrity to at least one portion of collected real-time data.

14. The system of claim 1, the update component implements real-time trouble-shooting based at least in part upon the collected real-time data.

15. The system of claim 1, further comprising a presentation component that provides at least one user interface to facilitate interaction between a user and the update component.

16. The system of claim 1, the RFID network comprises a collection of devices that form a sub-system which includes:
an RFID reader that receives an RFID signal; and
an RFID tag that transmits to at least one device.

17. A computer-implemented method that facilitates monitoring data within a radio frequency identification (RFID) network, comprising:
collecting real-time data associated with an entity in the RFID network; and
displaying real-time data for dynamic monitoring of the RFID network.

18. The method of claim 17, the entity corresponds to at least one of a device, a tag, a portion of code related to an RFID process, a portion of code, a component associated with the RFID process, an event handler, an aggregation, a transformation, a filter, a portion of managed code running in context of an RFID process, a machine related to an RFID process, a machine related to the RFID network, a machine related to an RFID server, or a machine related to a host providing a portion of an RFID service.

19. The method of claim 17, further comprising:
logging real-time data;
querying real-time data;
implementing real-time monitoring;
utilizing real-time management; and
employing real-time trouble-shooting.

20. A computer-implemented system that facilitates monitoring data within an RFID network, comprising:
means for utilizing a radio frequency identification (RFID) network that includes at least one device that receives data from a tag;
means for employing a radio frequency identification (RFID) process that utilizes at least a portion of the data received from the tag;
means for dynamically collecting a status related to a portion of at least one of the device, the tag, the RFID process, a component, and/or the RFID network to enable real-time and continuous monitoring thereof, and
means for displaying the status in connection with an administrator console.
